(19) United States
(12) Patent Application Publication
(10) Pub. No.: US 2015/0140967 A1
(43) Pub. Date: May 21, 2015

(54) BASE STATION AND USER EQUIPMENT AUTHENTICATION METHOD THEREOF

(71) Applicant: Institute For Information Industry, Taipei (TW)

(72) Inventors: Chun-Teh LEU, Taipei City (TW); Wen-Hsin WEI, Taipei City (TW)

(73) Assignee: Institute For Information Industry, Taipei (TW)

(21) Appl. No.: 14/101,005

(22) Filed: Dec. 9, 2013

(30) Foreign Application Priority Data
Nov. 18, 2013 (TW) 102141827

(51) Int. Cl. H04L 29/06; H04W 12/08; H04W 48/16

(52) U.S. Cl. CPC H04L 63/101; H04W 48/16; H04W 12/08
USPC 455/411

(57) ABSTRACT

A base station and a user equipment authentication method thereof are provided. The base station is for use in a wireless network system. The wireless network system includes the user equipment. The base station receives a login request message from the user equipment, and determines that the user equipment is recorded in a black list according to the login request message. The base station further rejects login of the user equipment according to the black list.

### PRIORITY

This application claims the benefits of priority based on Taiwan Patent Application No. 102141827 filed on Nov. 18, 2013, which is hereby incorporated by reference in its entirety.

### FIELD

The present invention relates to a base station for use in a wireless network and a user equipment authentication method thereof; more particularly, the base station for use in a wireless network and the user equipment authentication method thereof according to the present invention confirm the validity of a user equipment via a black list of the base station.

### BACKGROUND

In conventional wireless network architectures, a user equipment communicates with a back end server through a base station. When the user equipment logs into the base station of the wireless network available in the environment and needs to access network resources of the back end server, the back end server will firstly authenticate the identity of the user equipment. Afterwards, if the back end server determines that the user equipment is not authorized to access the network resources, the back end server will inform the base station to reject connection of the user equipment. On the contrary, if the back end server determines that the user equipment is authorized to access the network resources, the back end server will inform the base station to accept login of the user equipment.

However, when there are a lot of user equipments trying to login and access network resources within a certain wireless network coverage, the back end server will need to authenticate the identity for each user equipment. Hence, as the number of user equipments increases, it imposes a computational burden on the back end server. Furthermore, when a user equipment, which has been confirmed of lacking the authority to access network resources, keeps trying to login, the back end server needs to confirm its identity again, which causes unnecessary consumption of network resources.

Accordingly, in order to improve the overall efficiency and flexibility in use of the wireless network, it is important to ease the burden of the back end server in authenticating the user identity on the basis of the current wireless network hardware architectures.

### SUMMARY

A primary objective of certain embodiments of the present invention is to provide a user equipment authentication method for a base station. The base station is for use in a wireless network system. The wireless network system further comprises a user equipment. The user equipment authentication method comprises: (a) enabling the base station to receive a login request message from the user equipment; (b) enabling the base station to determine that the user equipment is recorded in a black list according to the login request message; and (c) enabling the base station to reject login of the user equipment according to the result of the step (b).

Another objective of certain embodiments of the present invention is to provide a base station for use in a wireless network. The wireless network further comprises a user equipment. The base station comprises a storage unit, a transceiving unit and a processing unit. The storage unit is configured to store a black list. The transceiving unit is configured to receive a login request message from the user equipment. The processing unit is configured to determine that the user equipment is recorded in the black list and reject login of the user equipment according to the login request message.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1A is a schematic view of a wireless network system according to a first embodiment of the present invention;

FIG. 1B is a block diagram of a base station according to the first embodiment of the present invention;

FIG. 2A is a schematic view of a wireless network system according to a second embodiment of the present invention;

FIG. 2B is a block diagram of a base station according to the second embodiment of the present invention;

FIG. 3 is a flowchart diagram of a user equipment authentication method according to a third embodiment of the present invention;

FIG. 4A to FIG. 4B are flowchart diagrams of a user equipment authentication method according to a fourth embodiment of the present invention;

FIG. 5 is a flowchart diagram of a user equipment authentication method according to a fifth embodiment of the present invention; and

FIG. 6A to FIG. 6B are flowchart diagrams of a user equipment authentication method according to a sixth embodiment of the present invention.

### DETAILED DESCRIPTION

In the following description, the present invention will be explained with reference to example embodiments thereof. However, these example embodiments are not intended to limit the present invention to any specific examples, embodiments, environment, applications or implementations described in these example embodiments. Therefore, description of these example embodiments is only for purpose of illustration rather than to limit the present invention. In the following embodiments and the attached drawings, elements unrelated to the present invention are omitted from depiction; and dimensional relationships among individual elements in the attached drawings are illustrated only for ease of understanding, but not to limit the actual scale.

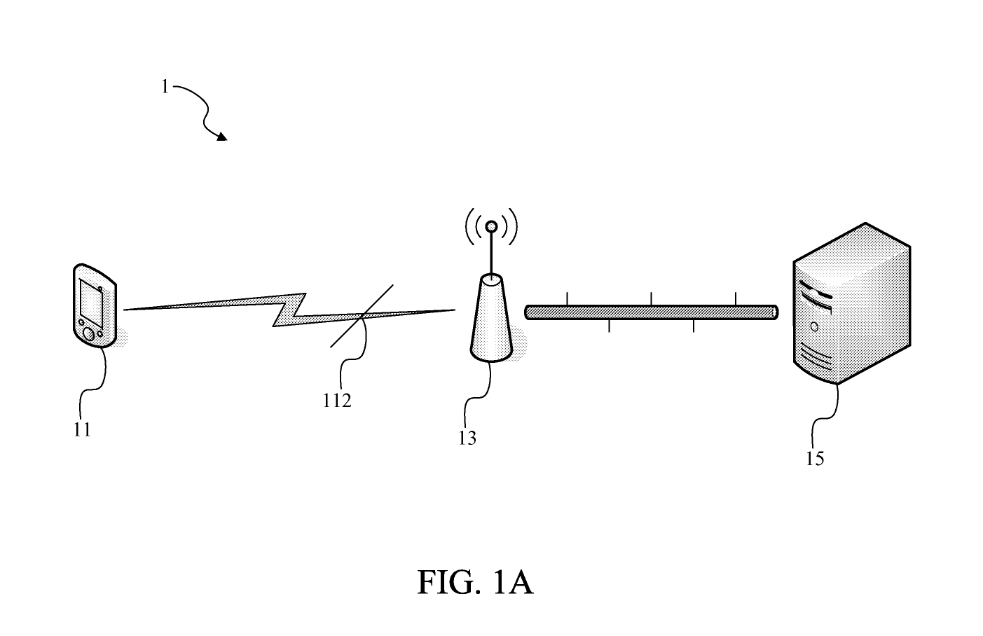

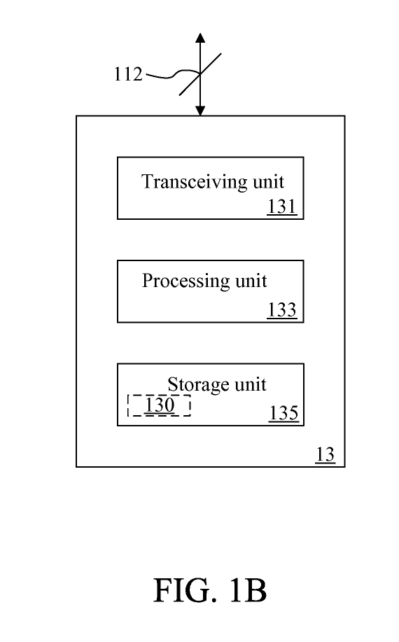

Please refer to FIG. 1A and FIG. 1B together. FIG. 1A is a schematic view of a wireless network system 1 according to a first embodiment of the present invention. The wireless network system 1 comprises a user equipment 11, a base station 13 and a back end server 15. FIG. 1B is a block diagram of the base station 13 according to the first embodiment of the present invention. The base station 13 comprises a transceiving unit 131, a processing unit 133, and a storage unit 135 which stores a black list 130 therein. Hereinbelow, interactions between the network elements will be further described.

Firstly, when the user equipment 11 needs to log into the base station 13 and access network resources of the back end server 15, the user equipment 11 sends a login request message 112 to the base station 13. After the login request message 112 is received by the transceiving unit 131 of the base station 13, the processing unit 133 of the base station 13 can determine whether the user equipment 11 is recorded in the black list 130 according to the login request message 112.

In detail, the black list 130 is used for recording a list of user equipments which are not authorized. Therefore, if the processing unit 133 of the base station 13 determines that the user equipment 11 is indeed recorded in the black list 130, the processing unit 133 of the base station 13 can reject login of the user equipment 11; in other words, the user equipment 11's further access to resources of the back end sever 15 will be rejected.

Thus, the base station 13 in the first embodiment of the present invention may firstly determine whether the user equipment 11 has the authority to access network resources when the user equipment 11 logs in, which can prevent the back end server 15 from consuming the important computational resources to determine the validity of the user equipment 11.

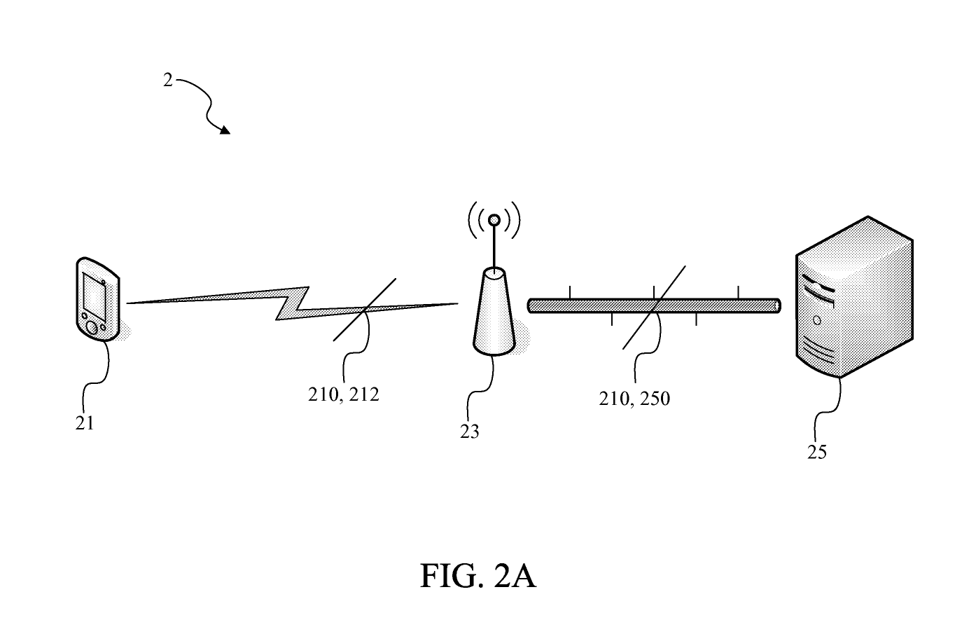

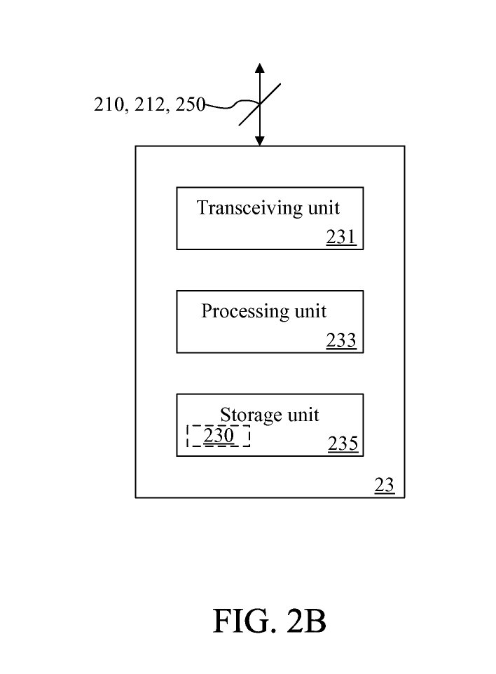

Please refer to FIG. 2A and FIG. 2B together. FIG. 2A is a schematic view of a wireless network system 2 according to a second embodiment of the present invention. The wireless network system 2 comprises a user equipment 21, a base station 23 and a back end server 25. FIG. 2B is a block diagram of the base station 23 according to the second embodiment of the present invention. The base station 23 comprises a transceiving unit 231, a processing unit 233, and a storage unit 235 which stores a black list 230 therein. The second embodiment differs from the previous embodiment in that the second embodiment describes how to manage and use the black list in more details. Hereinbelow, interactions between the network elements will be further described.

Firstly, it is assumed that in the second embodiment, the user equipment 21 is not recorded in the black list 230. When the user equipment 21 needs to log into the base station 23 and access network resources of the back end server 25, the user equipment 21 will send a first-time login request message 210 to the base station 23. After the first-time login request message 210 is received by the transceiving unit 231 of the base station 23, the transceiving unit 231 of the base station 23 transmits the first-time login request message 210 to the back end server 25.

Afterwards, the back end server 25 can determine whether the user equipment 21 has the authority to access network resources according to the first-time login request message 210. In the second embodiment, the back end server 25 determines that the authentication of the user equipment 21 fails, and transmits a response message 250 to the base station 23 to inform the base station 23 that the user equipment 21 has no qualification for authentication. And then, after the transceiving unit 231 of the base station 23 receives the response message 250, the processing unit 233 of the base station 23 can accordingly record the user equipment 21 into the black list 230.

In this way, when the user equipment 21 keeps trying to log into the base station 23 and further sends a login request message 212 to the base station 23, the transceiving unit 231 of the base station 23 will, similarly, receive the login request message 212, and the processing unit 233 of the base station 23 can determine whether the user equipment 21 is recorded in the black list 230 according to the login request message 212.

Because the user equipment 21 has been recorded in the black list 230 at the previous first-time login, the processing unit 233 of the base station 23 can determine that the user equipment 21 has indeed been recorded in the black list 230. Thus, the processing unit 233 of the base station 23 can reject login of the user equipment 21. It shall be particularly appreciated that, in the second embodiment, the transceiving unit 231 of the base station 23 can further stop sending any rejecting messages to the user equipment 21. Accordingly, the user equipment 21 will not request re-login within a certain time because it didn't receive any rejecting message. This can temporarily ease the message processing burden of the base station 23.

On the other hand, in the second embodiment, the base station 23 can further update the content of the black list 230 in two ways. In the first way, the processing unit 233 of the base station 23 can check the record of each user equipment in the black list 230 periodically (e.g., every 5 minutes). When the processing unit 233 determines that an update period of another user equipment (not shown) in the black list 230 exceeds a default period (e.g. 5 minutes), i.e., when the record of another user equipment is not updated due to further messages of the another user equipment within the default period (i.e., the processing unit 233 determines that no message is received from the another user equipment within the time period), it means the another user equipment no longer has the willingness to log in or has left the wireless network coverage. Accordingly, the processing unit 233 of the base station 23 can remove the record of the another user equipment from the black list 230.

Instead, when the processing unit 233 determines that messages were received again from the another user equipment within the time period, it means the another user equipment still keeps trying to log in and access network resources. In this case, the processing unit 233 will only update the update period of the another user equipment in the black list 230 so that whether the record of the another user equipment expires can be determined subsequently.

In the second way, the processing unit 233 of the base station 23 can check the records of the black list 230 simultaneously when the content of the black list 230 is altered. Particularly, when another user equipment (not shown) is recorded in the black list 230, the processing unit 233 will check the record of each user equipment in the black list 230 correspondingly. Similarly, when the processing unit 233 determines that no message is received from the another user equipment within the time period, it means the another user equipment no longer has the willingness to log in or has left the wireless network coverage. Accordingly, the processing unit 233 of the base station 23 can also remove the record of the another user equipment from the black list 230.

Similarly, when the processing unit 233 determines that messages were received again from the another user equipment within the time period, it means the another user equipment still keeps trying to log in and access network resources. In this case, the processing unit 233 will only update the update period of the another user equipment in the black list 230 so that whether the record of the another user equipment expires can be determined subsequently.

In the second embodiment, as the number of unauthorized user equipments increases in the wireless network system 2 (i.e., the number of the records of user equipments increases in the black list 230), contention for connection channels of the base station 23 will be caused between the unauthorized user equipments and the authorized user equipments. In view of this, the base station 23 may make corresponding adjustments to improve the rate of successful connection between the authorized user equipments and the base station 23.

Further, when the processing unit 233 of the base station 23 determines that the number of user equipments recorded in the black list 230 exceeds a threshold value, the processing unit 233 of the base station 23 can increase an initial access resource used in communication of the base station 23 (e.g., in a WiMAX network, increase the number of blocks of a ranging sub-channel of the base station). In this way, the rate of successful connection between the authorized user equipment and the base station 23 can be substantially improved. On the other hand, when the processing unit 233 of the base station 23 determines that the number of user equipments recorded in the black list 230 goes below the threshold value, the processing unit 233 of the base station 23 can restore the initial access resource to the default value.

It shall be particularly appreciated that, whether the number of the user equipments exceeds the threshold value is affected by the content of the black list 230 only after records of user equipments are added or deleted; therefore, whether the number of the user equipments recorded in the black list 230 exceeds the threshold value may be determined after alterations have been made to the content of the black list 230.

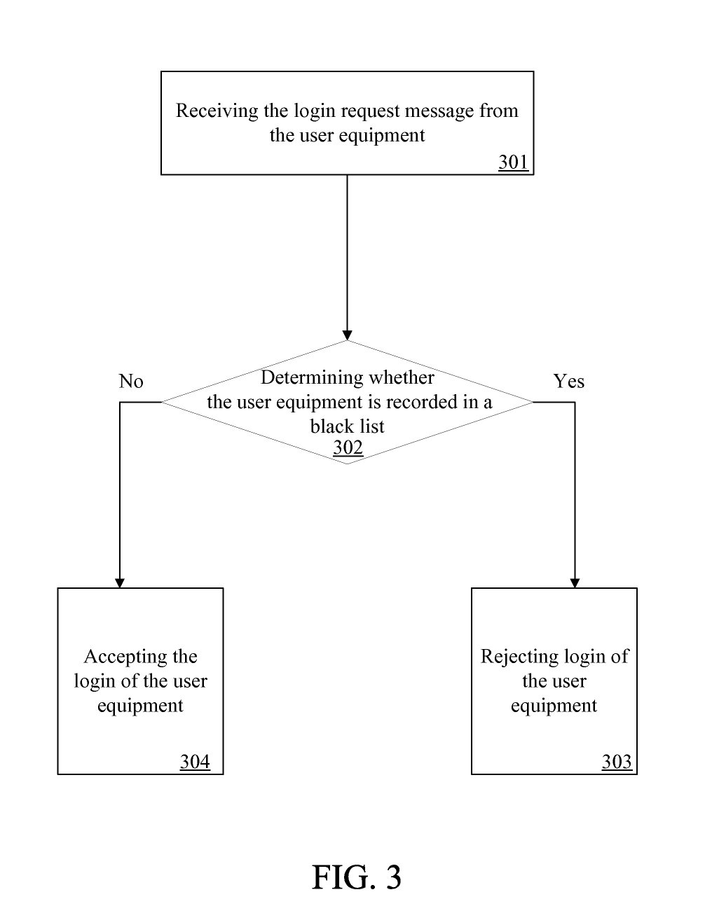

A third embodiment of the present invention is a mobile station authentication method, a flowchart diagram of which is shown in FIG. 3. The method of the third embodiment is used for a base station (e.g., the base station of the aforesaid embodiments). The base station is for use in a wireless network system. The wireless network system further comprises a user equipment and a back end sever. The detailed steps of the third embodiment are as follows.

First of all, when a user equipment needs to log into the base station and access network resources of the back end server, the user equipment sends a login request message to the base station. Correspondingly, step 301 is executed to enable the base station to receive the login request message from the user equipment. Next, step 302 is executed to enable the base station to determine whether the user equipment is recorded in a black list according to the login request message. The black list is stored in the base station.

If the user equipment is recorded in the black list, step 303 is executed to enable the base station to reject login of the user equipment. On the contrary, if the user equipment is not recorded in the black list, step 304 is executed to enable the base station to accept the login of the user equipment.

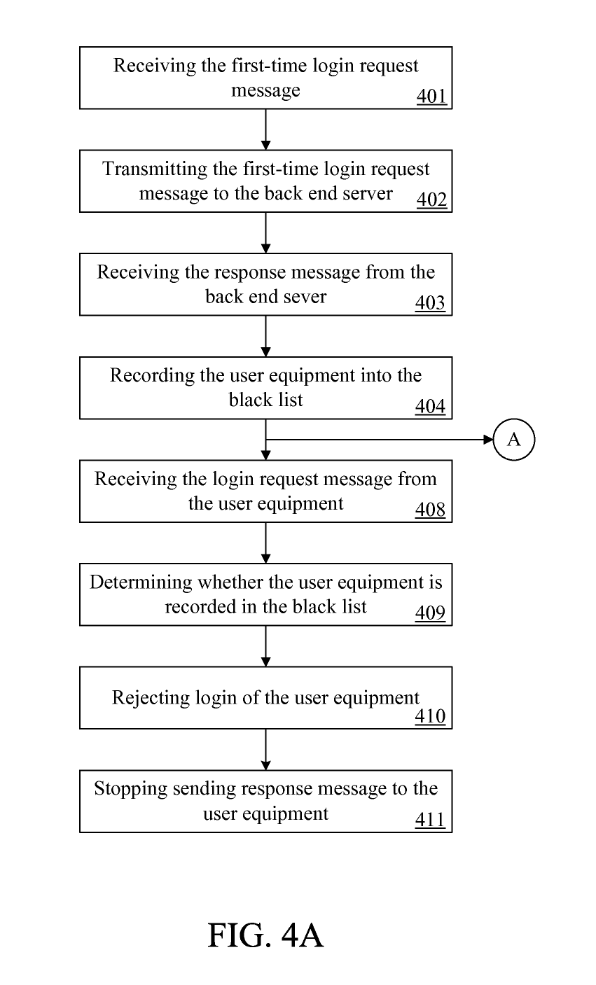

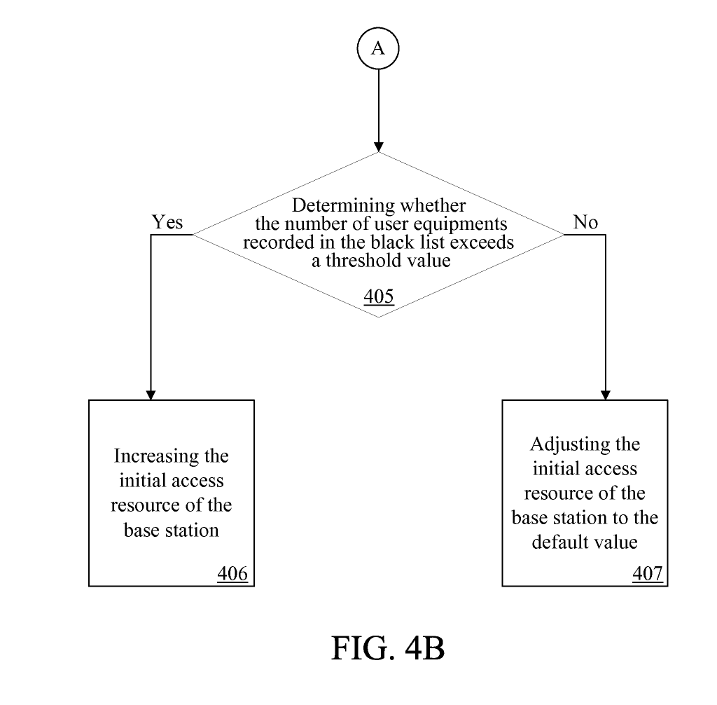

A fourth embodiment of the present invention is a mobile station authentication method, a flowchart diagram of which is shown in FIG. 4A and FIG. 4B. The method of the fourth embodiment is used for a base station (e.g., the base station of the aforesaid embodiments). The base station is for use in a wireless network system. The wireless network system further comprises a user equipment and a back end sever. The detailed steps of the fourth embodiment are as follows.

It is assumed that in the fourth embodiment, a user equipment has not yet logged into the wireless network. First of all, when the user equipment needs to log into the base station and access network resources of the back end server, the user equipment sends a first-time login request message to the base station. Correspondingly, step 401 is executed to enable the base station to receive the first-time login request message. Step 402 is executed to enable the base station to transmit the first-time login request message to the back end server so that the back end server determines that the user equipment authentication fails according to the first-time login request message and transmits a response message back to the base station. Then, step 403 is executed to enable the base station to receive the response message. Step 404 is executed to enable the base station to record the user equipment into the black list.

Thereafter, as the number of unauthorized user equipments increases in the wireless network system, contention for connection channel of the base station will be caused between the unauthorized user equipments and the authorized user equipments. Thus, the base station may make corresponding adjustments to improve the rate of successful connection between the authorized user equipment and the base station.

Further, step 405 may be executed simultaneously to enable the base station to determine that the number of the user equipments recorded in the black list exceeds a threshold value. When the number of the user equipments exceeds a threshold value, step 406 is executed to enable the base station to increase an initial access resource used in communication of the base station. Thus, the rate of successful connection between the authorized user equipment and the base station can be substantially improved.

On the other hand, when the base station determines that the number of the user equipments recorded in the black list does not exceed the threshold value, step 407 is executed to enable the base station to restore the initial access resource to the default value. Thereby, effects of increasing the access resource on the data transmission can be eliminated. It shall be particularly appreciated that, in the fourth embodiment, the step 405 to the step 407 are executed after the base station has recorded the user equipment into the black list; however this is not intended to limit the execution order. As will be readily appreciated by those skilled in the art, the step 405 to the step 407 can be executed at any appropriate time to determine whether the number of the user equipments recorded in the black list exceeds the threshold value.

Then, when the user equipment keeps trying to log into the base station and access network resources of the back end server, the user equipment will firstly send a login request message to the base station. Step 408 is executed to enable the base station to receive the login request message from the user equipment. Similarly, after the base station receives the login request message, the base station can determine whether the user equipment is recorded in the black list according to the login request message.

Because the user equipment has been recorded in the black list at the previous first-time login, step 409 is executed to enable the base station to determine that the user equipment is recorded in the black list. Next, step 410 is executed to enable the base station to reject login of the user equipment. Similarly, step 411 is executed to enable the base station to stop sending response message to the user equipment, which can temporarily suspend the user equipment's continuous sending of login messages and ease the burden of the base station.

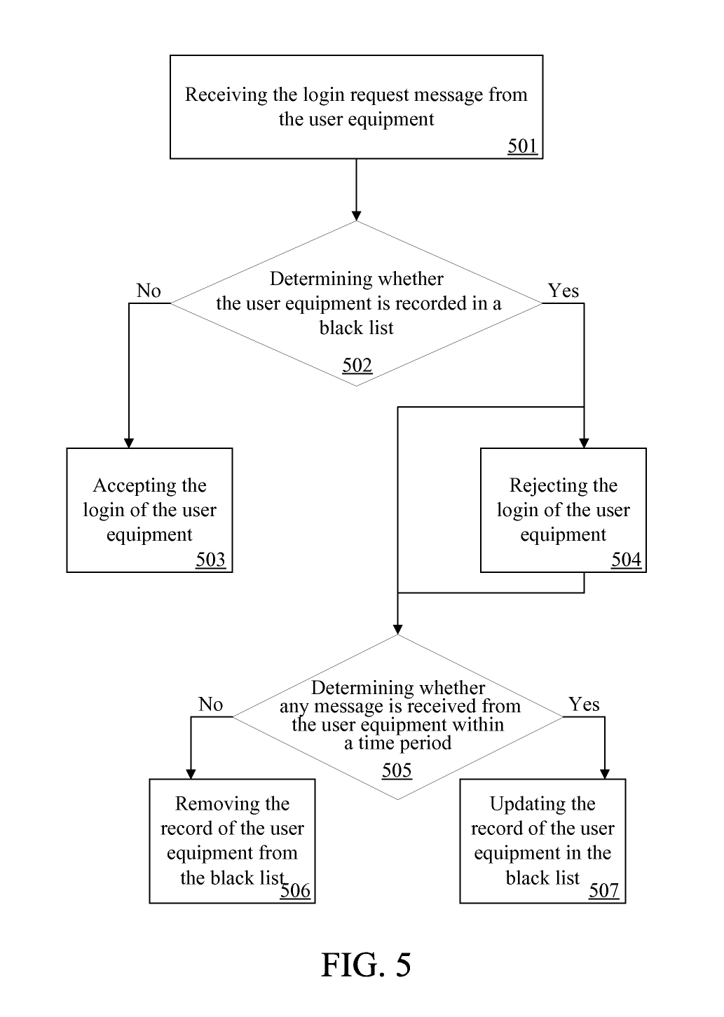

A fifth embodiment of the present invention is a mobile station authentication method, flowchart diagrams of which are shown in FIG. 5. The method of the fifth embodiment is used for a base station (e.g., the base station of the aforesaid embodiments). The base station is for use in a wireless network system. The wireless network system further comprises a user equipment and a back end sever. The detailed steps of the fifth embodiment are as follows.

Similarly, when a user equipment needs to log into the base station and access network resources of the back end server, the user equipment sends a login request message to the base station. Therefore, step 501 is executed to enable the base station to receive the login request message from the user equipment. Next, step 502 is executed to enable the base station to determine whether the user equipment is recorded in a black list according to the login request message. The black list is stored in the base station. If the user equipment is not recorded in the black list, step 503 is executed to enable the base station to accept login of the user equipment. On the contrary, if the user equipment is recorded in the black list, step 504 is executed to enable the base station to reject the login of the user equipment.

On the other hand, the base station can further update and maintain the content of the black list simultaneously in the fifth embodiment. Specifically, as shown in the flowchart diagram, after it is determined that the user equipment is recorded in the black list in the step 502 or after login of the user equipment is rejected in the step 504, step 505 can be executed to enable the base station to determine whether the base station receives any message from the user equipment within a time period. If the base station has not received any message from the user equipment within the time period, it means the user equipment no longer has the willingness to log in or has left the wireless network range. Thus, step 506 is executed to enable the base station to remove the record of the user equipment from the black list. Instead, if the base station receives messages from the user equipment within the time period, it means the user equipment is still within the communication coverage of the base station and step 507 is executed to enable the base station to update the record of the user equipment in the black list.

Similarly, in the fifth embodiment, the step 505 to the step 507 may be executed after the base station has determined that the user equipment is recorded in the black list or the base station has rejected login of the user equipment; however, this is not intended to limit the execution order. As will be readily appreciated by those skilled in the art, the step 505 to the step 507 can be executed at any appropriate time to update the content of the black list in real time.

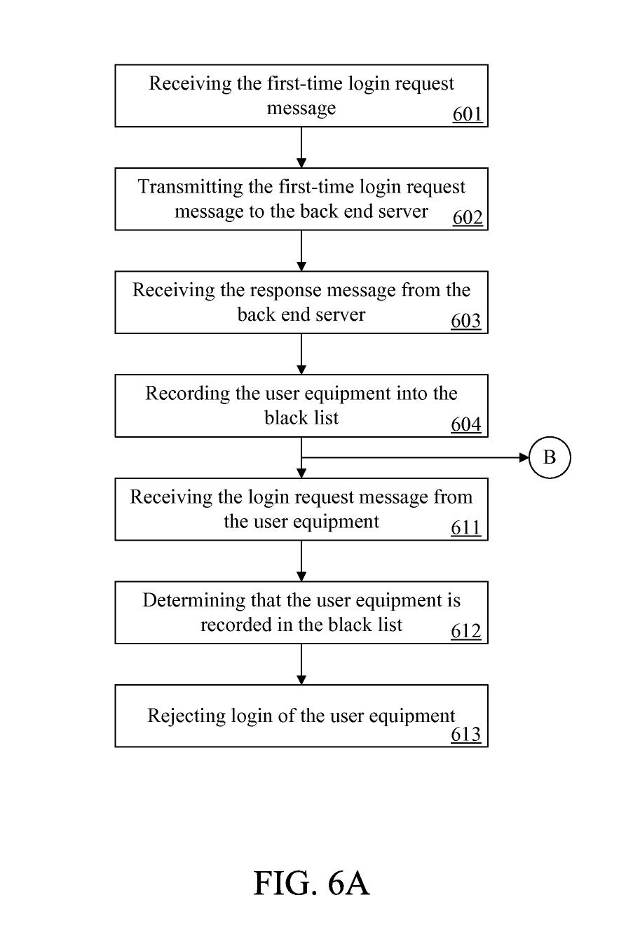

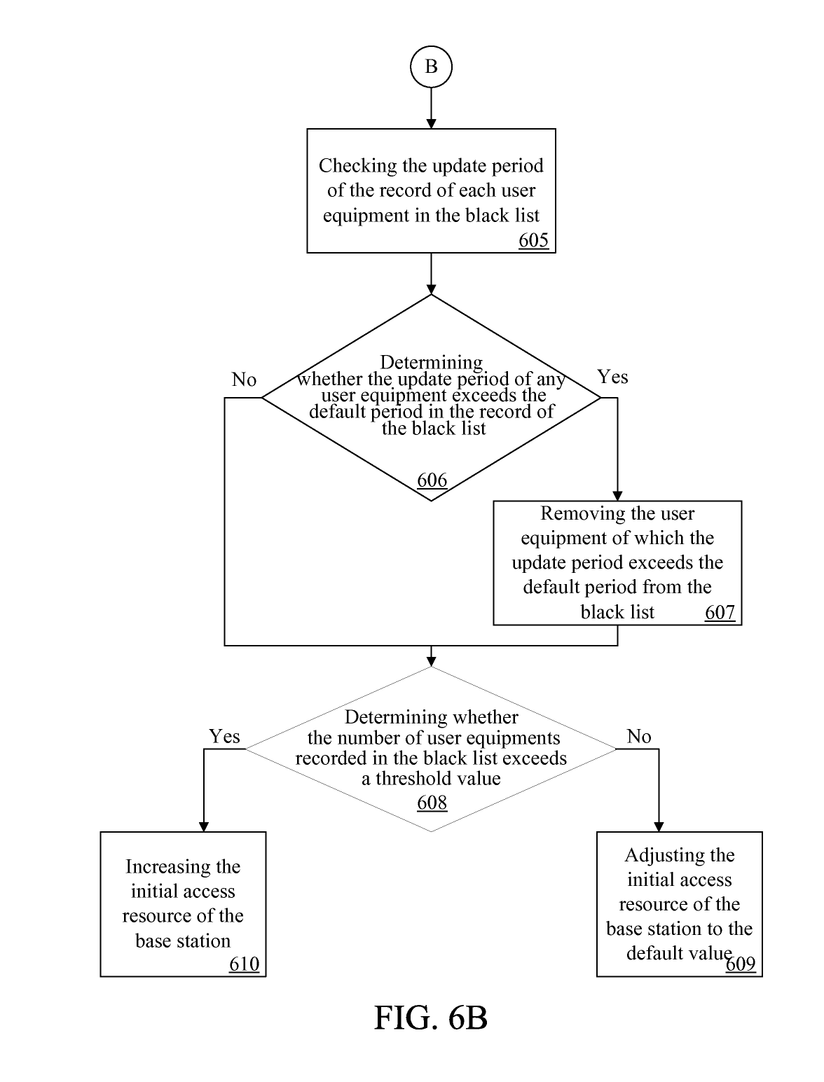

A sixth embodiment of the present invention is a mobile station authentication method, flowchart diagrams of which are shown in FIG. 6A and FIG. 6B. The method of the sixth embodiment is used for a base station (e.g., the base station of the aforesaid embodiments). The base station is for use in a wireless network system. The wireless network system further comprises a user equipment and a back end sever. The detailed steps of the sixth embodiment are as follows.

It is assumed that, in the sixth embodiment, a user equipment has not yet logged into the wireless network. First of all, when the user equipment needs to log into the base station and access network resources of the back end server, the user equipment sends a first-time login request message to the base station. Correspondingly, step 601 is executed to enable the base station to receive the first-time login request message. Step 602 is executed to enable the base station to transmit the first-time login request message to the back end server so that the back end server determines that the user equipment authentication fails according to the first-time login request message and transmits a response message back to the base station. Then, step 603 is executed to enable the base station to receive the response message. Step 604 is executed to enable the base station to record the user equipment into the black list.

And then, step 611 is executed to enable the base station to receive the login request message from the user equipment. Similarly, after the login request message is received by the base station, the base station can determine whether the user equipment is recorded in the black list according to the login request message. Because the user equipment has been recorded in the black list at the previous first-time login, step 612 is executed to enable the base station to determine that the user equipment is recorded in the black list. Next, step 613 is executed to enable the base station to reject login of the user equipment.

It shall be particularly appreciated that, since the content of the black list is altered during the execution process of the method, an associated function of maintaining the black list can be activated at a particular time. In the sixth embodiment, the function of maintaining the black list is activated after the step 604. Step 605 is executed to enable the base station to check the update period of the record of each user equipment in the black list. Then, step 606 is executed to enable the base station to determine whether the update period of any user equipment exceeds the default period according to the record of the black list. In other words, step 606 is executed to enable the base station to determine whether the record of any user equipment is not updated over the default period.

If the base station determines that the update period of some user equipment exceeds the default period, step 607 is executed to enable the base station to remove this user equipment from the black list. Then, because the content of the black list is altered again, step 608 is executed to enable the base station to determine whether the number of the user equipments recorded in the black list exceeds a threshold value. If it does not exceed the threshold value, step 609 is executed to enable the base station to adjust an initial access resource to a default value; and if it exceeds the threshold value, step 610 is executed to enable the base station to increase the initial access resource. Instead, if no record of the user equipment in the black list exceeds the default period, step 608 and the subsequent determination are immediately executed to finish the maintenance of the black list.

Similarly, in the sixth embodiment, the step 605 to the step 610 may be executed after the base station has determined that the user equipment is recorded in the black list or the base station has rejected login of the user equipment; however this is not intended to limit the execution order. As will be readily appreciated by those skilled in the art, the step 605 to the step 610 can be executed at any appropriate time or periodically to update the content of the black list in real time.

It shall be particularly appreciated that, the base station, the user equipment, and the back end server of the aforesaid embodiments may be a base station, a subscriber as well as a gateway server, an authentication authorization access server and a home location register server of a WiMAX network respectively; or they may be an evolved NodeB and a home evolved NodeB, a user equipment as well as a mobility management entity and a home subscriber server of an LTE (Long Term Evolution) network respectively. However, this is not intended to limit the network implementations of the present invention.

According to the above descriptions, the base station of the present invention can filter user equipments based on validity thereof through the use and management of the black list to ease the burden of the back end server, and also, the overall flexibility in use of the wireless network system can be improved by increasing an initial access resource.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A user equipment authentication method for a base station, the base station being used in a wireless network system, and the wireless network system further comprising a user equipment, the user equipment authentication method comprising:
(a) enabling the base station to receive a login request message from the user equipment;
(b) enabling the base station to determine that the user equipment is recorded in a black list according to the login request message, wherein the black list is stored in the base station; and
(c) enabling the base station to reject login of the user equipment according to the result of the step (b).

2. The user equipment authentication method as claimed in claim 1, further comprising:
(d) enabling the base station to stop sending any message to the user equipment according to the result of the step (c).

3. The user equipment authentication method as claimed in claim 1, wherein the wireless network system further comprises a back end server, and the user equipment authentication method further comprises the following steps before the step (a):
(a1) enabling the base station to receive a first-time login request message from the user equipment;
(a2) enabling the base station to transmit the first-time login request message to the back end server so that the back end server determines that the user equipment authentication fails according to the first-time login request message;
(a3) enabling the base station to receive a response message from the back end server after the step (a1); and
(a4) enabling the base station to record the user equipment into the black list according to the response message.

4. The user equipment authentication method as claimed in claim 3, further comprising:
(d) enabling the base station to determine that the number of the user equipments recorded in the black list exceeds a threshold value; and
(e) enabling the base station to increase an initial access resource of the base station according to the result of the step (d).

5. The user equipment authentication method as claimed in claim 1, further comprising:
(d) enabling the base station to determine that no message of the user equipment is received within a time period; and
(e) enabling the base station to remove the user equipment from the black list according to the result of the step (d).

6. The user equipment authentication method as claimed in claim 3, further comprising:
(d) enabling the base station to determine that an update period of another user equipment recorded in the black list exceeds a default period; and
(e) enabling the base station to remove the another user equipment from the black list according to the result of the step (d).

7. A base station for use in a wireless network, the wireless network further comprising a user equipment, the base station comprising:
a storage unit, being configured to store a black list;
a transceiving unit, being configured to receive a login request message from the user equipment; and
a processing unit, being configured to determine that the user equipment is recorded in the black list and reject login of the user equipment according to the login request message.

8. The base station as claimed in claim 7, wherein the transceiving unit is further configured to stop sending any message to the user equipment.

9. The base station as claimed in claim 7, wherein the wireless network system further comprises a back end server; the transceiving unit is further configured to receive a first-time login request message from the user equipment before receiving the login request message, and transmit the first-time login request message to the back end server so that the back end server determines that the user equipment authentication fails according to the first-time login request message; the transceiving unit is further configured to receive a response message from the back end server; and the processing unit is further configured to record the user equipment into the black list according to the response message.

10. The base station as claimed in claim 9, wherein the processing unit is further configured to determine that the number of the user equipments recorded in the black list exceeds a threshold value and increase an initial access resource.

11. The base station as claimed in claim 7, wherein the processing unit is further configured to determine that no message of the user equipment is received by the transceiving unit within a time period, and remove the user equipment from the black list.

12. The base station as claimed in claim 9, wherein the processing unit is further configured to determine that an update period of another user equipment recorded in the black list exceeds a default period, and remove the another user equipment from the black list.
